(19) United States
(12) Patent Application Publication
(10) Pub. No.: US 2013/0335179 A1
(43) Pub. Date: Dec. 19, 2013

(54) HIGH-CORROSION RESISTANT SINTERED NDFEB MAGNET AND PREPARATION METHOD THEREFOR

(71) Applicants: Renjie Chen, Zhejiang (CN); Aru Yan, Zhejiang (CN); Dong Li, Zhejiang (CN); Qiaoying Zhou, Zhejiang (CN); Longjie Zhou, Zhejiang (CN); Alexandra Wilde, Renningen (DE)

(72) Inventors: Renjie Chen, Zhejiang (CN); Aru Yan, Zhejiang (CN); Dong Li, Zhejiang (CN); Qiaoying Zhou, Zhejiang (CN); Longjie Zhou, Zhejiang (CN); Alexandra Wilde, Renningen (DE)

(21) Appl. No.: 13/879,171

(22) PCT Filed: Oct. 14, 2011
(86) PCT No.: PCT/CN2011/080771

§ 371 Date: Jul. 31, 2013

(30) Foreign Application Priority Data
Oct. 15, 2010 (CN) 201010515292.4

(51) Int. Cl. H01F 1/01

(52) U.S. Cl. CPC H01F 1/01
USPC 335/302

(57) ABSTRACT

High corrosion resistant sintered NdFeB magnets are provided with a composition by mass % of NdₓRₓ₁Fe_{100-(x+x1+y+y1+z)}T_{y}M_{y1}B_{z}, where 24≦x≦33, 0≦x1≦15, 1.43≦y≦16.43, 0.1≦y1≦0.6, 0.91≦z≦1.07, R is one or more selected from the group consisting of Dy, Tb, Pr, Ce and Gd, T is one or more selected from the group consisting of Co, Cu and Al, M is one or more selected from the group consisting of Nb, Zr, Ti, Cr and Mo, and M is distributed within the grain boundary phase of the NdFeB magnets.

### FIELD OF THE INVENTION

The present invention relates to high corrosion resistant sintered NdFeB magnets and a preparation process thereof.

### BACKGROUND

In 1983, Sagawa et al. in Sumitomo Special Metals Corporation of Japan employed a powder metallurgy process to develop a high-performance NdFeB permanent magnetic material, which proclaims the birth of the third generation of rare earth permanent magnetic material. Compared with the previous rare earth permanent magnetic material, NdFeB-based rare earth permanent magnetic material has the following advantages: (a) iron, which is cheap in price, is used as a main component, Nd, which has a smaller content in the magnet, is also a widely available rare earth metal, and therefore the price of the permanent magnets is remarkably reduced; (b) iron atoms rich in high magnetic moment render the saturation magnetic polarization of the material to reach 4πMs=1.6 T, with magnetic crystal anisotropy field of μ₀Hₐ=7 T, so that a record high maximum magnetic energy product is achieved, the theoretical value of the maximum magnetic energy product being as high as 512 kJ/m³ (64MGOe); and (c) Nd₂Fe₁₄B has a tetragonal structure which tends to form a phase. The practically used sintered Nd—Fe—B magnets are mainly composed of a main phase of hard magnetic phase Nd₂Fe₁₄B, a secondary phase of boron-rich phase and Nd-rich phase etc.

As the permanent magnetic material with excellent overall performances as known hitherto, NdFeB permanent magnetic material has been a research focus of worldwide researchers since its invention, and has been used in various aspects of life. In the 21st century, with the rapid development of high-tech industries such as computers, electronics and information technologies, production of NdFeB magnets enters a period of rapid growth.

Replacing ferrite magnets with sintered NdFeB magnets has become an important development trend of electric motor industry, especially for electric motors used in electric vehicles and hybrid power vehicles.

With the expansion of the application field of NdFeB magnets, its working environment is becoming more and more complex, and requirements on the material's corrosion resistance are higher. Especially, when used in generators and electric motors, magnets are often required to have a good corrosion resistance at high temperatures.

Common NdFeB magnets have a low corrosion resistance against air (mainly O₂), moisture and salt. This disadvantage has seriously hampered its application in generators and electric motors.

Therefore, it is necessary to provide new NdFeB magnets having a good corrosion resistance, so as to overcome the disadvantages in prior art.

### SUMMARY

In order to overcome the defects of existing NdFeB magnets, the present invention provides high corrosion resistant sintered NdFeB magnets.

Specifically, according to example embodiments of the present invention, high corrosion resistant NdFeB sintered magnets are provided, which magnets are characterized in that the composition of the magnets by mass % is NdₓRₓ₁Fe_{100-(x+x1+y+y1+z)}T_{y}M_{y1}B_{z}, wherein 24≦x≦33, 0≦x1≦15, 1.43≦y≦16.43, 0.1≦y1≦0.6, 0.91≦z≦1.07, R is one or more selected from the group consisting of Dy, Tb, Pr, Ce and Gd, T is one or more selected from the group consisting of Co, Cu and Al, M is one or more selected from the group consisting of Nb, Zr, Ti, Cr and Mo, and M is distributed within the grain boundary phase of the NdFeB magnets.

Example embodiments of the present invention also provide a preparation process of the NdFeB magnets, said process comprising:

providing a main phase alloy powder, where the composition of the main phase alloy by mass % is NdₓRₓ₁Fe_{100-(x+x1+y+z)}T_{y}B_{z}, where 24≦x≦y≦33, 0≦x1≦15, 1.43≦16.43, 0.91≦z≦1.07, R is one or more selected from the group consisting of Dy, Tb, Pr, Ce and Gd, and T is one or more selected from the group consisting of Co, Cu, and Al;

providing an auxiliary phase alloy powder, where the composition of the auxiliary phase alloy by mass % is NdₓRₓ₁Fe_{100-(x+x1+y+y1+z)}T_{y}M_{y1}B_{z}, where 24≦x≦63, 0≦x1≦19, 1.43≦Y≦16.43, 6≦y1≦18, 0.91≦z≦1.07, R is one or more selected from the group consisting of Dy, Tb, Pr, Ce and Gd, T is one or more selected from the group consisting of Co, Cu, and Al, and M is one or more selected from the group consisting of Nb, Zr, Ti, Cr and Mo;

mixing the main phase alloy powder with the auxiliary phase alloy powder, where the content of the auxiliary phase alloy powder is 1-10% by the total mass;

press-molding the mixed powder in a magnetic field into a preform, and then isostatic pressing at a pressure above 200 MPa; and

placing the molded preform in a high-vacuum sintering furnace for sintering, so as to obtain sintered magnets.

Compared with the preparation process of NdFeB magnets in the prior art, in the present preparation process of NdFeB magnets, adding only a small amount, even a trace amount, of refractory metals into the sintered NdFeB magnets significantly improves the high-temperature corrosion resistance of the NdFeB magnets. At the same time, the addition of refractory metals would not impair the magnetic properties of NdFeB magnets.

### DETAILED DESCRIPTION

In order to improve the high temperature corrosion resistance of sintered NdFeB magnets, two technical routes can be taken. One is to improve the intrinsic corrosion resistance of the NdFeB magnets, and the other is to apply a coating on the surface of the magnets. However, the durability of the corrosion resistant coating is usually insufficient to meet the requirements of practical use.

The present invention employs the first technical route, that is, to improve the intrinsic corrosion resistance of the NdFeB magnets.

In the present invention, by adding refractory metals into the sintered NdFeB magnets using a bi-phase alloy sintering method, the refractory metals are added to the grain boundary phase of the NdFeB magnets, so as to improve the high temperature corrosion resistance of the NdFeB magnets. The added refractory metals may be Nb, Zr, Ti, Cr or Mo, preferably Nb, Zr or Ti. The chemical composition of the finally obtained sintered NdFeB magnets of the present invention can be readily determined by existing analytical methods.

Compared with Nd, Ce is more abundant in the earth crust and has a lower cost, and therefore Ce is often used in the NdFeB magnets to replace Nd, so as to reduce the cost of the product.

Gd is a kind of heavy rare earth element, and is useful for stabilizing the magnetic properties of the magnets material at high temperatures.

The bi-phase alloy sintering method is a recently developed new method for producing sintered NdFeB magnets material. The method uses an alloy of two components, where, after coarsely crushing the alloy to a certain degree, the two components are mixed by a certain ratio, oriented, and press molded, and then magnets are produced through sintering, tempering, and detection.

In the present invention, by means of the bi-phase alloy sintering method, adding only a small amount, even a trace amount, of refractory metals into the sintered NdFeB magnets significantly improves the high-temperature corrosion resistance of the NdFeB magnets.

This is because in the bi-phase alloy sintering method, the main-phase alloy does not melt substantially, and the refractory metals contained in the auxiliary phase alloy are mainly distributed in the grain boundary phase in the magnets. In this way, with only a small amount of refractory metals, the high-temperature corrosion resistance of the magnets can be significantly improved without impairing the magnetic properties of NdFeB magnets because the refractory metals are mainly distributed in the grain boundary phase.

Although there are attempts to add refractory metals into the NdFeB magnets in the prior art, these attempts often add refractory metals into the main phase alloy. As a result, a large amount of refractory metals are used, but the improvement of high-temperature corrosion resistance is not obvious, and the magnetic properties of the magnets are adversely harmed.

The modification, according to example embodiments of the present invention, by the grain boundary phase is based on the experience in the production of the sintered NdFeB magnets material, since in the grain boundary phase alloy (auxiliary phase alloy) designed by the present invention, the content of rare earth is high, and its melting point is lower than the that of the main phase in the sintered magnets. At sintering temperature, the grain boundary phase is a liquid phase, and the main phase is still a solid phase, and therefore the elements in the grain boundary phase alloy hardly penetrate into the main phase. This is due to the characteristics of NdFeB sintering and the bi-phase alloy sintering process.

According to an example of the present invention, a bi-phase alloy sintering method of producing NdFeB magnets includes the following steps:
providing a main phase alloy formed into a NdFeB ingot alloy by a casting process or formed into a NdFeB strip by a strip casting process;
crushing the main phase alloy using a hydrogen decrepitation method or a mechanical crushing method;
subsequent to the crushing, milling the main phase alloy into powders by a jet mill or a ball mill, so that the main phase alloy powders are of an average particle diameter of 2-5 μm;
providing an auxiliary phase alloy powder formed into an ingot alloy by arc melting, formed into a strip by a strip casting process, or formed into a quick quenching band by a quick quenching process;
crushing the auxiliary phase alloy using a hydrogen decrepitation method or a mechanical crushing method;
subsequent to the crushing, milling the auxiliary phase alloy into powders by a jet mill or a ball mill, so that the auxiliary phase alloy powders are of an average particle diameter of 2-5 μm;
mixing the main phase alloy powder with the auxiliary phase alloy powder, where the content of the auxiliary phase alloy powder is 1-10% by the total mass, the powders being mixed homogeneously;
press-molding the mixed powder in a magnetic field into a preform;
subsequently to the press-molding, isostatic pressing the mixed powder at a pressure above 200 MPa; and
placing the molded preform in a high-vacuum sintering furnace for sintering at a temperature between 1040-1120° C. for 2-5 hours, so as to obtain sintered magnets.

During the above isostatic pressing treatment, the higher the pressure is, the more beneficial it would be for the properties of the material, but an overhigh pressure would impose more requirements on the safety facilities, and also result in a volume increase of the apparatus, resulting in increased production costs.

As for the sintering treatment, for example, in the NdFeB magnets preparation process of the present invention, the sintering in the high vacuum sintering furnace can be carried out at 1040-1120° C. for 2-5 hours to obtain sintered magnets.

Depending on the specific conditions, the magnets may be primarily tempered at 850-950° C. for 2-3 hours, and then secondarily tempered at 450-550° C. for 2-5 hours, so as to obtain sintered magnets.

The tempering treatment is optional, so that none, only one, or both of the primary tempering and secondary tempering can be carried out.

The present invention is now described in detail with reference to the following examples. However, the examples are only for illustrative purposes and do not limit the present invention in any manner.

### Example 1

According to an example embodiment, a main phase alloy with a composition of Pr₆Nd₂₄Fe_{67.45}Dy_{0.5}CO_{0.6}Cu_{0.04}Al_{0.25}Zr_{0.2}B_{0.96} (mass percent) is formed into strips by a strip casting process, and then formed into powders having an average particle diameter of 3.6 microns using the hydrogen decrepitation and jet milling process. In an example embodiment, the powders are oriented in a magnetic field of 2 T and press molded. According to an example embodiment, under a pressure of 300 MPa, isostatic pressing is performed for 20 seconds. According to an example embodiment, the preform is then placed in a vacuum furnace at 1080° C. and sintered for 2 hours, followed by two stage heat treatments, including a primary heat treatment performed at 875° C. for 2 hours and a secondary heat treatment performed at 560° C. for 2 hours. Thus, master alloy sintered magnets can be obtained, with magnetic characteristics, which are for example as summarized in Table 1.

According to an example embodiment, the auxiliary phase alloy with a composition of Pr₆Nd₂₄Fe_{47.45}Dy_{0.5}Nb₂₀Co_{0.6}Cu_{0.04}Al_{0.25}Zr_{0.2}B_{0.96} (mass percent) is formed into strips by means of a strip casting process, and then formed into powders with an average particle diameter of 3.6 microns using the hydrogen decrepitation and jet milling process. According to an example embodiment, the auxiliary alloy powder which accounts for 1 mass % of the total mass is added into the above main phase alloy powders and mixed homogeneously, the composition of the final alloy being: Pr₆Nd₂₄Fe_{67.25}Dy_{0.5}Nb_{0.2}Co_{0.6}Cu_{0.04}Al_{0.25}Zr_{0.2}B_{0.96} (mass percent). According to an example embodiment, subsequently, the same orientation, pressure molding process, isostatic pressing, vacuum sintering, and heat treatment as applied to the master alloy is applied to obtain the final magnets. The magnetic characteristics (20° C.) of the final magnets containing the auxiliary phase alloy are, according to an example embodiment, as summarized in Table 1.

In a performed example, the master alloy magnets and the final magnets containing the auxiliary phase alloy were respectively formed into magnets of two specifications: Φ10 mm×10 mm and Φ15 mm×3 mm, five pieces of each specification, 20 in total. Subsequently, HAST tests were carried out at the following experimental conditions: 130° C., 0.26 MPa, 168 hours. The mass loss of the master alloy magnets and the final magnets containing the auxiliary phase alloy are summarized in Table 1.

Corrosion Resistance Tests:

Autoclave tests were performed at 130° C. and a relative humidity of 95% for 168 hours, and high-temperature corrosion resistance of the produced magnets was evaluated.

The test results are shown in Table 1, and the data indicates that the surface corrosion of NdFeB magnets produced in Example 1 is significantly improved. Specifically, in the autoclave test, at 130° C. and a relative humidity of 95%, for 168 hours, the average mass loss decreased from 1.71 mg/cm² to 0.19 mg/cm².

Under the same test conditions, the surface corrosion of typical commercially available sintered NdFeB magnets is usually as high as 2 mg/cm².

Magnetic Flux Loss after Aging at a High Temperature:

After aging at 150° C. for 1000 hours, the magnetic flux loss of the magnets was measured.

Under the same aging conditions, the magnetic flux loss of the sintered NdFeB magnets of the present invention was only 0.77%.

Typically, the requirement on the magnetic flux loss of the commercially available magnets is that the magnetic flux loss within 3 hours at the working temperature is less than 5%. It can be seen that the performance of the magnetic flux loss of the magnets of the present invention is far superior to this requirement.

TABLE 1
Comparison of the magnetic properties and the average mass
loss between the master alloy magnets and the final sintered
magnets containing 1 mass % of the auxiliary alloy

| | | | | Average |
|---|---|---|---|---|
| | Remanence | Coercivity | Magnetic energy | mass loss |
| | (kGs) | (kOe) | product (MGOe) | (mg/cm²) |
| Master alloy | 13.5 | 11.8 | 44.2 | 1.71 |
| magnets | | | | |
| Final magnets | 13.45 | 11.65 | 43.6 | 0.19 |

### Example 2

According to an example embodiment, the main phase alloy with a composition of Nd₂₄Fe_{67.48}Tb_{0.8}Dy₅Co_{1.0}Zr_{0.2}Cu_{0.23}Al_{0.3}B_{0.99} (mass percent), and an auxiliary phase alloy with a composition of Nd₄₀Fe_{31.48}Tb_{0.8}Dy₅Co_{1.0}Zr_{0.2}Nb₂₀Cu_{0.23}Al_{0.3}B_{0.99} (mass percent) are formed into strips respectively by means of the strip casting process, and then formed into powders with an average particle diameter of 3.5 microns using the hydrogen decrepitation and jet milling process. According to an example embodiment, the auxiliary alloy powder which accounts for 1 mass % of the total mass is added into the above main phase alloy powders and mixed homogeneously, and the composition of the finally obtained alloy is: Nd_{24.16}Fe_{67.12}Tb_{0.8}Dy₅Co_{1.0}Nb_{0.2}Zr_{0.2}Cu_{0.23}Al_{0.3}B_{0.99} (mass percent). According to an example embodiment, subsequently, the master alloy powders and the final alloy powders are molded and oriented in a magnetic field of 2 T, and a 300 MPa isostatic pressing is performed for 20 seconds. According to an example embodiment, the produced preforms are then respectively placed in a vacuum furnace at 1090° C. and sintered for 2 hours, followed by two stage heat treatments, where the primary heat treatment is performed at 900° C. for 2 hours; and the secondary heat treatment is performed at 500° C. for 2 hours. Thus, according to an example embodiment, master alloy sintered magnets and final sintered magnets are obtained, where the magnetic characteristics (20° C.) of the produced master alloy magnets and the final sintered magnets thus obtained are as summarized in Table 2.

In an actual performance of this example, the master alloy magnets and the final magnets containing the auxiliary phase alloy were respectively formed into magnets of two specifications: Φ10 mm×10 mm and Φ15 mm×3 mm, five pieces of each specification, 20 in total. Subsequently, HAST tests were carried out at the following experimental conditions: 130° C., 0.26 MPa, 168 hours. The mass loss of the master alloy magnets and the final magnets containing the auxiliary phase alloy are summarized in Table 2.

Corrosion Resistance Tests:

Autoclave tests were performed at 130° C. and a relative humidity of 95% for 168 hours, and high-temperature corrosion resistance of the produced magnets was evaluated.

Test results are shown in Table 2, and the data indicates that the surface corrosion of NdFeB magnets produced in Example 2 is significantly improved. Specifically, in the autoclave test, at 130° C. and a relative humidity of 95%, for 168 hours, the average mass loss decreased from 1.6 mg/cm² to 0.13 mg/cm².

TABLE 2
Comparison of the magnetic properties and the average mass
loss between the master alloy magnets and the final sintered
magnets containing 1 mass % of the auxiliary alloy

| | | | | Average |
|---|---|---|---|---|
| | Remanence | Coercivity | Magnetic energy | mass loss |
| | (kGs) | (kOe) | product (MGOe) | (mg/cm²) |
| Master alloy | 11.9 | 25.2 | 35.1 | 1.6 |
| magnets | | | | |
| Final magnets | 11.8 | 24.5 | 34.5 | 0.13 |

It can be seen from the above examples that, in the present invention, by adding a small amount of refractory metals in a unique way, the high temperature stability and corrosion resistance of the magnets are significantly improved, and the magnetic properties of the magnets only slightly decreased.

This technical effect is never achieved in the prior art, and it can not be easily inferred by those skilled in the art.

Based on the previously described principles and specific examples, those skilled in the art can easily make modifications or design other equivalent embodiments. Those skilled in the art should understand that such equivalent embodiments are within the scope of the claims of the present application.

1-6. (canceled)

7. A high corrosion resistant sintered NdFeB magnet, comprising: NdₓRₓ₁Fe_{100-(x+x1+y+y1+z)}T_{y}M_{y1}B_{z}, wherein:
by mass % 24≦x≦33, 0≦x1≦15, 1.43≦y≦16.43, 0.1≦y1≦0.6, 0.91≦z≦1.07;
R is one or more selected from the group consisting of Dy, Tb, Pr, Ce and Gd;
T is one or more selected from the group consisting of Co, Cu and Al;
M is one or more selected from the group consisting of Nb, Zr, Ti, Cr and Mo; and
M is distributed within a grain boundary phase of the NdFeB magnet.

8. A method of manufacturing a high corrosion resistant sintered NdFeB magnet, the method comprising:
providing a main phase alloy powder, the composition of the main phase alloy being NdₓRₓ₁Fe_{100-(x+x1+y+z)}T_{y}B_{z}, wherein:
by mass %, 24≦x≦y≦33, 0≦x1≦15, 1.43≦16.43, 0.91≦z≦1.07;
R is one or more selected from the group consisting of Dy, Tb, Pr, Ce and Gd; and
T is one or more selected from the group consisting of Co, Cu, and Al;
providing an auxiliary phase alloy powder, the composition of the auxiliary phase alloy being NdₓRₓ₁Fe_{100-(x+x1+y+y1+z)}T_{y}M_{y1}B_{z}, wherein:
by mass %, 24≦x≦63, 0≦x1≦19, 1.43≦Y≦16.43, 6≦y1≦18, 0.91≦z≦1.07;
the content of Fe is 100−(x+x1+y+y1+z);
R is one or more selected from the group consisting of Dy, Tb, Pr, Ce and Gd;
T is one or more selected from the group consisting of Co, Cu, and Al; and
M is one or more selected from the group consisting of Nb, Zr, Ti, Cr and Mo;
mixing the main phase alloy powder with the auxiliary phase alloy powder, wherein the content of the auxiliary phase alloy powder is 1-10% by the total mass;
press-molding the mixed powder in a magnetic field into a preform;
subsequent to the press-molding, isostatic pressing at a pressure above 200 MPa; and
placing the molded preform in a high-vacuum sintering furnace for sintering.

9. The method of claim 8, wherein an average particle diameter of the main phase alloy powder is 2-5 μm.

10. The method of claim 8, wherein an average particle diameter of the auxiliary phase alloy powder is 2-5 μm.

11. The method of claim 8, wherein the molded preform is sintered at 1040-1120° C. for 2-5 hours in a high vacuum sintering furnace.

12. The preparation process of claim 11, further comprising tempering the molded preform at 850-950° C. for 2-3 hours.

13. The preparation process of claim 11, further comprising tempering the molded preform at 450-550° C. for 2-5 hours.

14. The preparation process of claim 11, further comprising tempering the molded preform in a primary tempering step at 850-950° C. for 2-3 hours and tempering the molded preform in a secondary tempering step at 450-550° C. for 2-5 hours.
